(19) United States
(12) Patent Application Publication
(10) Pub. No.: US 2025/0081175 A1
(43) Pub. Date: Mar. 6, 2025

(54) MULTI-CELL SCHEDULING WITH DIFFERENT NUMEROLOGIES

(71) Applicant: Apple Inc., Cupertino, CA (US)

(72) Inventors: Ankit Bhamri, Haar (DE); Dawei Zhang, Saratoga, CA (US); Haitong Sun, Saratoga, CA (US); Hong He, San Jose, CA (US); Seyed Ali Akbar Fakoorian, San Diego, CA (US); Sigen Ye, San Diego, CA (US); Wei Zeng, Saratoga, CA (US); Weidong Yang, San Diego, CA (US)

(73) Assignee: Apple Inc., Cupertino, CA (US)

(21) Appl. No.: 18/679,305

(22) Filed: May 30, 2024

Related U.S. Application Data
(60) Provisional application No. 63/535,475, filed on Aug. 30, 2023.

(51) Int. Cl. H04W 72/12; H04L 27/26; H04W 72/232

(52) U.S. Cl. CPC H04W 72/12; H04L 27/26025; H04W 72/232

(57) ABSTRACT

The present application relates to devices and components including apparatus, systems, and methods for multi-cell scheduling with different numerologies.

### RELATED APPLICATIONS

The present application claims priority to U.S. Provisional Application No. 63/535,475, filed Aug. 30, 2023, which is hereby incorporated by reference in its entirety.

### TECHNICAL FIELD

The present application relates to the field of wireless technologies and, in particular, to multi-cell scheduling with different numerologies.

### BACKGROUND

Third Generation Partnership Project (3GPP) Technical Specifications (TSs) provide that a base station can use downlink control information (DCI) transmitted in one serving cell to schedule uplink or downlink transmissions in a plurality of serving cells. Further enhancements are needed to account for various scenarios that may occur.

### BRIEF DESCRIPTION OF THE DRAWINGS

FIG. 1 illustrates a network environment in accordance with some embodiments.

FIG. 2 illustrates a scheduling diagram in accordance with some embodiments.

FIG. 3 is an operation flow/algorithmic structure in accordance with some embodiments.

FIG. 4 is another operation flow/algorithmic structure in accordance with some embodiments.

FIG. 5 is another operation flow/algorithmic structure in accordance with some embodiments.

FIG. 6 is an example UE in accordance with some embodiments.

FIG. 7 is an example base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A) B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

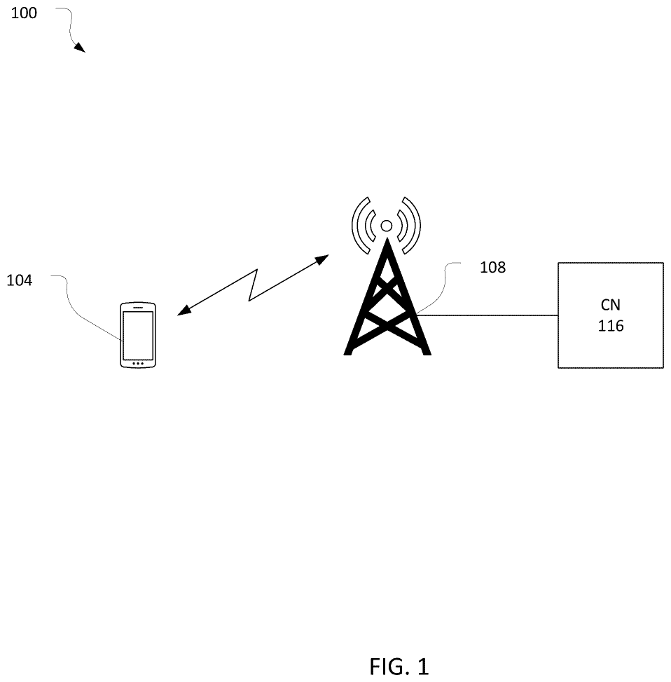

FIG. 1 illustrates a network environment 100 in accordance with some embodiments. The network environment 100 may include a UE 104 and a base station 108. In some embodiments, the base station 108 may provide one or more serving cells through which the UE 104 may communicate with a cellular network. The base station 108 may be part of a radio access network (RAN) that is coupled with a core network (CN) 116.

The UE 104 and the base station 108 may communicate over air interfaces compatible with Fifth Generation (5G) NR (or later) system standards as provided by Third Generation Partnership Project (3GPP) technical specifications.

Communication over the air interface may take place through various uplink or downlink physical channels. In the uplink, control and signaling may be transmitted via a physical uplink control channel (PUCCH) and data may be transmitted in a physical uplink shared channel (PUSCH). In the downlink, control and signaling may be transmitted via a physical downlink control channel (PDCCH) and data may be transmitted in a physical downlink shared channel (PDSCH).

Demodulation reference signals (DMRSs) may be transmitted for the different physical channels. A DMRS may be a sequence that is known to, or discoverable by, a receiver. The receiver may compare a received version of the DMRS with the known DMRS sequence that was transmitted to estimate an impact of the propagation channel. The receiver may then apply an inverse of the propagation channel during a demodulation process of a corresponding physical channel payload. A payload and its associated DMRS may be transmitted using a single antenna port.

The information from the physical channels may be mapped to resources of a resource grid. There is one resource grid for a given antenna port, subcarrier spacing (SCS) configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a resource block. A resource element group (REG) may include one resource block and one OFDM symbol in the time domain, for example, 12 resource elements. A REG bundle includes L REGs, where L is determined by RRC parameter REG-bundle-size. A control channel element (CCE) may represent a group of resources used for a PDCCH transmission. One CCE may be mapped to a number of REGs, for example, six REGs.

A CCE aggregation level may indicate a number of CCEs and, therefore, REGs and resource elements, used for a PDCCH transmission. The CCE aggregation level may be, for example, 1, 2, 4, 8, or 16. In general, the base station 108 may use a higher CCE aggregation level, which corresponds to a lower coding rate and higher redundancy, for UEs in weak coverage, and lower CCE aggregation levels for UEs in good coverage.

To decode a PDCCH transmission, the UE 104 may rely on search space (SS) and control channel resource set (CORESET) configurations. In general, the UE 104 may determine a frequency location, number of symbols, and transmission configuration indicator (TCI) state of the search space based on a CORESET configuration, and may determine a slot and starting symbol index of the search space 304 based on an SS configuration.

In some embodiments, the SS and the CORESET may be configured by radio resource control (RRC) signaling. For example, the base station 108 may use RRC signals to provide a ControlResourceSet information element to configure the CORESET and a SearchSpace information element to configure the search space. In some embodiments, some or all of the configuration information may be predefined and available at the UE 104.

The ControlResourceSet information element may include parameters such as, for example, a control resource set identifier; frequency domain resources; a duration; a CCE-REG mapping type; a precoder granularity; TCI states to add or release; an indication of whether TCI is present in DCI; and a PDCCH DMRS scrambling identifier. In some embodiments, the ControlResourceSet information element may include additional or alternative parameters.

The SearchSpace information element may define how and where the UE 104 is to search for PDCCH candidates. Each search space may be associated with one CORESET. The SearchSpace information element may include parameters such as, for example, search space identifier, a CORESET identifier, a monitoring slot periodicity and offset, a duration, a monitoring symbols within slot, and a number of candidates. In some embodiments, the SearchSpace information element may include additional or alternative parameters.

The UE 104 may monitor a PDCCH by blindly decoding PDCCH candidates based on the parameters provided by the CORESET/SS configurations. For example, the UE 104 may identify PDDCH candidates for different aggregation levels, and blindly decode the PDCCH candidates until it correctly decodes a PDCCH transmission. The blind decoding of a PDCCH candidate may include performing channel estimations on constituent CCEs. The blind decoding operations may be computationally intensive with the increase of the BD candidates and CCEs for which channel estimation is required. Thus, 3GPP TSs may define BD/CCE budgets, which provide for a maximum number of PDCCH candidates that require blind decodes and maximum number of CCEs that require channel estimations.

Section 10 of 3GGP TS 38.213 v17.6.0 (2023 Jun. 26) defines various UE procedures for receiving control information. This section provides specific BD/CCE budgets that relate to numerologies with which a particular serving cell is configured. A serving cell may be configured with numerologies (for example, subcarrier spacing (SCS) values) of, for example, 15 kHz, 30 kHz, 60 kHz, 120 kHz, 240 kHz, 480 kHz, or 960 kHz. Some BD/CCE budgets provided by TS 38.213 include 44/56 for 15 kHz SCS, 36/56 for 30 kHz SCS, and 22/48 for 60 kHz SCS. Other BD/CCE budgets may be defined/used in accordance with various embodiments

Some networks that comply with 3GPP Release 18 TSs may employ multi-cell scheduling in which DCI transmitted in one cell schedules PDSCH/PUSCH in a set of cells. “Multi-cell,” as used herein, refers to two or more cells. DCI format 1_3 may be used to schedule PDSCH transmissions, while DCI format 0_3 may be used to schedule PUSCH transmissions.

The BD/CCE budget and size of the DCI transmission may be determined according to current Release 18 3GPP TSs as follows. For a set of cells that is configured for multi-cell scheduling, an existing DCI size budget may be maintained on each cell of the set of cells. The DCI size of DCI format 0_3/1_3 and the BD/CCE budget may be counted on one cell among the set of cells (referred to as a reference cell). The reference cell may be defined as the scheduling cell if the scheduling cell is included in the set of cells and search space of the DCI format 0_3/1_3 is configured only on the scheduling cell; or one cell of the set of cells in which search space of DCI format 0_3/1_3 is configured on one cell of the set of cells and associated with the search space of the scheduling cell with the same search space ID if search space of the DCI format 0_3/1_3 is configured on the cell in addition to the scheduling cell. It may be up to a base station on which cell the SS of the DCI format 0_3/1_3 is configured.

Current Release 18 3GPP TSs may also address Release 17 BD/CCE limits for any given cell. This may be done by providing that, for the reference cell, a total number of configured BD/CCEs for both DCI formats 0_3/1_3 and legacy DCI formats (if configured) does not exceed the Release 17 limits. For other cells in the sets of cells, the Release 17 limits for PDCCH/DCI monitoring and BD/CCE counting rules for legacy DCI formats (not including DCI formats 0_3/1_3) may apply.

According to current Release 18 3GPP TSs, a UE can be configured with a set of cells belonging to a same SCS and carrier type. If the scheduling cell is outside of the set of co-scheduled cells, it can have a different SCS and carrier type as compared to the set of co-scheduled cells. However, if the scheduling cell is inside the set of co-scheduled cells, it must have the same SCS and carrier type as the other cells.

Embodiments of the present disclosure provide for co-scheduled cells within a set to have different SCS with multi-cell PUSCH/PDSCH scheduling. This may provide operators more scheduling flexibility as the multi-cell DCI is capable of being used in a greater variety of network implementations.

The present disclosure addresses a number of aspects in which the co-scheduled cells within the set configured for multi-cell scheduling have different SCSs. For example, embodiments describe how and on which cell(s) to count the BD/CCE, while keeping the same limits as legacy for each cell. This may be considered for two cases, e.g., when the scheduling cell is reference cell and when the scheduling cell is not the reference cell.

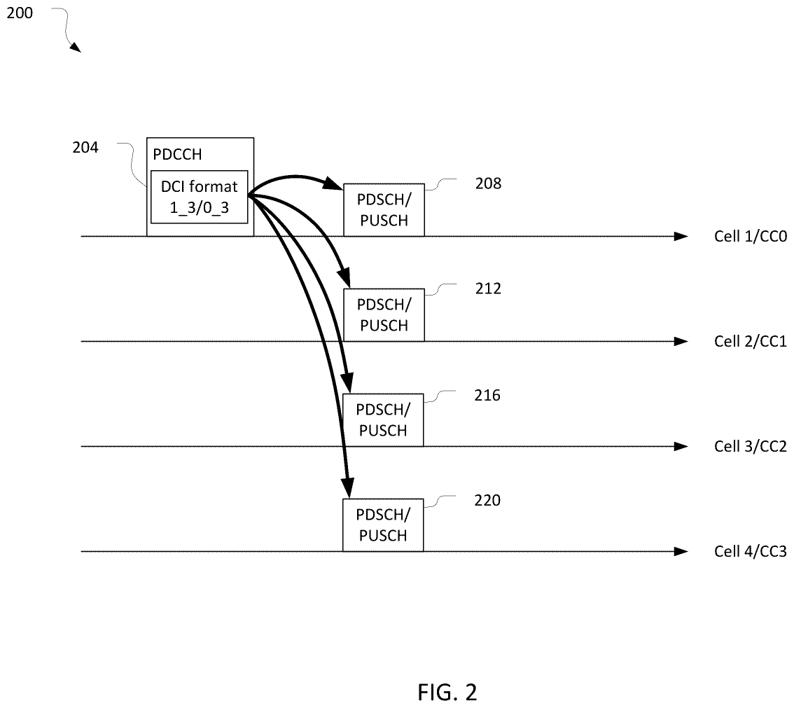

FIG. 2 illustrates a scheduling diagram 200 illustrating multi-cell scheduling in accordance with some embodiments. The scheduling diagram 200 may include a PDCCH 204 of a first cell. The first cell may be on a first component carrier (e.g., CC0). The PDCCH 204 may carry DCI that schedules PDSCH/PUSCH in multiple cells. As shown, the DCI in PDCCH 204 schedules PDSCH/PUSCH in three cells, for example, PDSCH/PUSCH 208 in cell 1, PDSCH/PUSCH 212 in cell 2 on a second CC (e.g., CC1), PDSCH/PUSCH 216 in cell 3 on a third CC (e.g., CC2), and PDSCH/PUSCH 220 in cell 4 on a fourth CC (e.g., CC3). In accordance with various embodiments discussed herein, the set of co-scheduled cells, e.g., cells 1-4, may include at least two different numerologies. In some embodiments, the UE 104 may perform BD operations based on BD/CCE budgets determined based on numerologies of a selected cell of the co-scheduled cells.

In a first aspect of this disclosure, referred to as aspect 1-1, the UE 104 may indicate a capability to support multi-cell PDSCH/PUSCH scheduling and for a set of cells, the co-scheduled cells can be (re)configured with different SCS for the respective active bandwidth parts (BWPs) and the scheduling cell is within the set of cells. The UE 104 may then perform the BD/CCE counting for multi-cell PDSCH/PUSCH scheduling DCI format (for example DCI format 1_3/0_3) on the scheduling cell for a set of cells as follows. Among all the cells within the set of cells, the lowest configured numerology is determined and the BD/CCE budget corresponding to the lowest numerology is applied.

Consider an example in which CC0 has a 15 kHz SCS, CC1 has a 15 kHz SCS, CC2 has a 30 kHz SCS, and CC3 has a 30 kHz SCS. In this example, CC0-CC3 correspond to the set of cells and CC0 is the scheduling cell (as shown in FIG. 2). In this example, the lowest numerology is 15 kHz and the maximum number of PDCCH candidates that require blind decodes corresponding to 15 kHz is 44 and the maximum number of CCEs that require channel estimations corresponding to 15 kHz is 56. Thus, the total BD/CCE budget for multi-cell PDSCH/PUSCH scheduling DCI format in this example is 44/56.

A variation of the first aspect, referred to as aspect 1-2, may account for instances in which the scheduling cell can be configured with search space for multi-cell scheduling DCI formats and for single-cell scheduling DCI formats. In this case, a total BD/CCE budget for both multi-cell and single-cell scheduling DCI formats may be based on the BD/CCE budget corresponding to the lowest numerology, as described above with respect to aspect 1-1. However, for single-cell scheduling DCI formats, which may also be referred to as legacy DCI formats, the BD/CCE budget limit corresponding to a numerology of the scheduled cell may also be followed.

Consider an example in which CC0 has a 15 kHz SCS, CC1 has a 15 kHz SCS, CC2 has a 30 kHz SCS, and CC3 has a 30 kHz SCS. If CC0 can be configured with a legacy (e.g., single-cell) DCI format for scheduling CC2, then the corresponding BD/CCE limit corresponding to 30 kHz (for example, 36/56) may be followed for monitoring legacy DCI formats, while the total BD/CCE budget for both multi-cell and single-cell scheduling DCI formats is 44/56 (based on lowest numerology of the set, e.g., 15 kHz).

Further consider, for example, a first SS (SS1) configured for single-cell DCI formats and having 20 BD candidates, a second SS (SS2) configured for multi-cell DCI formats and having 4 BD candidates, and a third SS (SS3) configured for single-cell DCI formats and having 20 BD candidates. In this example, the BD budget may be [44,36], which indicates a total BD budget of 44 and a single-cell BD budget of 36. If the SSs were processed in order from lowest index to highest index, 20 of the 20 BD candidates of SS1 may be blindly decoded (resulting in a remaining BD budget of [24,16]), 4 of the 4 BD candidates of SS2 may be blindly decoded (resulting in a remaining BD budget of [20,16]), and 16 of the 20 BD candidates of SS3 may be blindly decoded (resulting in a remaining BD budget of [4,0]).

In a second aspect of this disclosure, referred to as aspect 2-1, the UE 104 may indicate a capability to support multi-cell PDSCH/PUSCH scheduling and for a set of cells, the co-scheduled cells can be (re)configured with different SCS for the respective active BWPs and scheduling cell is within the set of cells. The UE 104 may then perform the BD/CCE counting for multi-cell PDSCH/PUSCH scheduling DCI format (for example DCI format 1_3/0_3) on the scheduling cell for a set of cells as follows. Among all the cells within the set of cells, the highest configured numerology is determined and the BD/CCE budget corresponding to the highest numerology is applied.

Consider an example in which CC0 has a 15 kHz SCS, CC1 has a 15 kHz SCS, CC2 has a 30 kHz SCS, and CC3 has a 30 kHz SCS. In this example, CC0-CC3 correspond to the set of cells and CC0 is the scheduling cell (as shown in FIG. 2). In this example, the highest numerology is 30 kHz and the maximum number of PDCCH candidates that require blind decodes corresponding to 30 kHz is 36 and the maximum number of CCEs that require channel estimations corresponding to 30 kHz is 56. Thus, the total BD/CCE budget for multi-cell PDSCH/PUSCH scheduling DCI format in this example is 36/56.

A variation of the second aspect, referred to as aspect 2-2, may account for instances in which the scheduling cell can be configured with search space for multi-cell scheduling DCI formats and for single-cell scheduling DCI formats. In this case, three budgets may be defined. A total BD/CCE budget for both multi-cell and single-cell scheduling DCI formats may be based on the BD/CCE budget corresponding to the lowest numerology. A multi-cell BD/CCE budget may be based on the BD/CCE budget corresponding to the highest numerology, as described above with respect to aspect 2-1. And a single-cell BD/CCE budget may be based on a BD/CCE budget limit corresponding to a numerology of the scheduled cell.

Consider an example in which CC0 has a 15 kHz SCS, CC1 has a 15 kHz SCS, CC2 has a 30 kHz SCS, and CC3 has a 30 kHz SCS. If CC0 can be configured with a legacy (e.g., single-cell) DCI format for scheduling CC2, then the single-cell BD/CCE limit may correspond to 30 kHz (for example, 36/56) based on the numerology of CC2, the multi-cell BD/CCE limit may correspond to 30 kHz (for example, 36/56) as that is the highest SCS of the set, and the total BD/CCE budget for both multi-cell and single-cell scheduling DCI formats may correspond to 15 kHz (for example, 44/56) as that is the lowest SCS of the set.

Further consider the following example using the BD budgets determined above, for example, [36 total, 36 multi-cell, 44 single-cell], with a first SS (SS1) configured for single-cell DCI formats and having 20 BD candidates, a second SS (SS2) configured for multi-cell DCI formats and having 4 BD candidates, and a third SS (SS3) configured for single-cell DCI formats and having 20 BD candidates. If the SSs were processed in order from lowest index to highest index, 20 of the 20 BD candidates of SS1 may be blindly decoded (resulting in a remaining BD budget of [16, 36, 24]), 4 of the 4 BD candidates of SS2 may be blindly decoded (resulting in a remaining BD budget of [12, 32, 24]), and 12 of the 20 BD candidates of SS3 may be blindly decoded (resulting in a remaining BD budget of [0, 32, 12]).

A third aspect of this disclosure may apply to a situation in which the UE 104 indicates a capability to support multi-cell PDSCH/PUSCH scheduling and for a set of cells, the co-scheduled cells can be (re)configured with different SCS for the respective active BWPs. In this situation, the BD/CCE counting for multi-cell PDSCH/PUSCH scheduling DCI format (for example DCI format 1_3/0_3) may be done on the cell(s) for a set of cells as follows.

Among all the cells within the set of cells, one or more subsets of cells may be determined, with each subset containing cell(s) belonging to one numerology. From each subset, a corresponding reference cell may be selected. A numerology associated with the reference cell may then be used to determine the BD/CCE budget for the corresponding subset. The cell of a subset that is to be selected as the reference cell may be configured/indicated/determined in a variety of different ways. For example, the selection of the reference cell from the subset may be based on a network configuration (for example, the base station 108 may provide an indication of a specific cell that is to serve as the reference cell), defined by a 3GPP TS, or based on a predetermined rule (for example, the cell associated with the lowest/highest index is to be selected as the reference cell).

Consider, for example, that a co-scheduled set includes CC0 (15 kHz), CC1 (15 kHz), CC2 (30 kHz) and CC3 (30 kHz). Then one reference cell corresponding to 15 kHz may be configured/indicated/determined from CC0 or CC1 and another reference cell corresponding to 30 kHz may be configured/indicated/determined from CC2 or CC3. Corresponding BD/CCE budget may be applied to each reference cell. For example, a BD/CCE budget for the reference cell corresponding to 15 kHz may be 44/56 and the BD/CCE budget for the reference cell corresponding to 30 kHz may be 36/56. This BD/CCE budget may be the total budget including both legacy (single-cell) DCI formats and new (multi-cell) DCI formats.

The BD/CCE budgets corresponding to the various reference cells may be maintained from the perspective of the UE 104; however, the monitoring of the PDCCH candidates based on the budgets may be done on the scheduling cell. In some embodiments, an overall BD/CCE budget may correspond to a sum of the BD/CCE budgets for the different reference cells. For example, the UE 104 in this example will have total BD/CCE budget of (44+36)/(56+56) for these two reference cells. However, in some instances, the UE 104 may report a total number of BD/CCE for carrier aggregation operation across all the SCSs. In this case, the sum of budgets for the two reference cells may be limited by the reported total number.

A fourth aspect of this disclosure may apply to a situation in which the UE 104 indicates a capability to support multi-cell PDSCH/PUSCH scheduling and for a set of cells, the co-scheduled cells can be (re)configured with different SCS for the respective active BWPs. In this situation, the BD/CCE counting for multi-cell PDSCH/PUSCH scheduling DCI format (for example DCI format 1_3/0_3) may be done on the cell for a set of cells as follows.

Among all the cells within the set of cells, the cell with the highest numerology among all the cells within the set may be selected as the reference cell. For example, if the set includes CC0 (15 kHz), CC1 (15 kHz), CC2 (30 kHz) and CC4 (60 kHz), CC4 is determined as the reference cell and the BD/CCE counting is done on CC4 and the budget limitations corresponding to CC4's numerology of 60 KHz is applied, for example, 22/48. This budget may refer to the total budget including both legacy (single-cell) DCI formats and new (multi-cell) DCI formats.

In case when the highest numerology is associated with two or more cells, then the cell that is to be selected from the two or more cells as the reference cell may be configured/indicated/determined in a variety of different ways. For example, the selection of the reference cell from the two or more cells may be based on a network configuration (for example, the base station 108 may provide an indication of a specific cell that is to serve as the reference cell), defined by a 3GPP TS, or based on a predetermined rule (for example, the cell associated with the lowest/highest index is to be selected as the reference cell).

A fifth aspect of this disclosure may apply to a situation in which the UE 104 indicates a capability to support multi-cell PDSCH/PUSCH scheduling and for a set of cells, the co-scheduled cells can be (re)configured with different SCS for the respective active BWPs. In this situation, the BD/CCE counting for multi-cell PDSCH/PUSCH scheduling DCI format (for example DCI format 1_3/0_3) may be done on the cell for a set of cells as follows.

Among all the cells within the set of cells, the cell with the lowest numerology among all the cells within the set may be selected as the reference cell. For example, if the set includes CC0 (15 kHz), CC1 (15 kHz), CC2 (30 kHz) and CC4 (60 kHz), then CC0 may be selected as the reference cell and the BD/CCE counting may be done on CC0 and the budget limitations corresponding to CC0's numerology of 15 kHz may be applied, for example, 44/56. This budget is the total budget including both legacy (single-cell) DCI formats and new (multi-cell) DCI formats.

In case when the lowest numerology is associated with two or more cells, then the cell that is to be selected from the two or more cells as the reference cell may be configured/indicated/determined in a variety of different ways. For example, the selection of the reference cell from the two or more cells may be based on a network configuration (for example, the base station 108 may provide an indication of a specific cell that is to serve as the reference cell), defined by a 3GPP TS, or based on a predetermined rule (for example, the cell associated with the lowest/highest index is to be selected as the reference cell).

In accordance with a sixth aspect of this disclosure, the UE 104 may report one or more of the UE capabilities that relate to multi-cell scheduling with co-scheduled cells belonging to different SCSs. The base station 108, upon receiving the UE capabilities, may configure and schedule the set of co-scheduled cells accordingly.

In some embodiments, the UE 104 may report whether it supports co-scheduled cells belonging to different SCSs. For example, the UE 104 may indicate a capability to support multi-cell PDSCH/PUSCH scheduling for a set of co-scheduled cells that can be (re)configured with different SCSs for the respective active BWPs. In some embodiments, this capability signaling may be separate from a signaled capability of whether the UE 104 supports multi-cell PDSCH/PUSCH scheduling for a set of co-scheduled cells that are to be (re)configured with the same SCS.

In some embodiments, the UE 104 may report how many different SCSs can be configured for co-scheduled cells within the set. In one option, this number may be reported corresponding to different maximum number of co-scheduled cells within a set. For example, if a maximum of four cells within the set may be reported by the UE 104, then the UE 104 may report that up to three different SCSs can be configured; if a maximum of four cells within the set is to be reported by the UE 104, then the UE 104 may report that up to two different SCSs can be configured; and if a maximum of two cells within the set are to be reported by the UE 104, then the UE 104 may not support different SCSs.

In some embodiments, the UE 104 may additionally/alternatively report different combinations of SCS supported for co-scheduled cells within the set. For example, if three different SCSs may be configured, the UE 104 may report that it supports a combination of 15 kHz, 30 kHz, and 60 kHz SCSs or a combination of 120 kHz, 480 kHz, and 960 kHz SCSs.

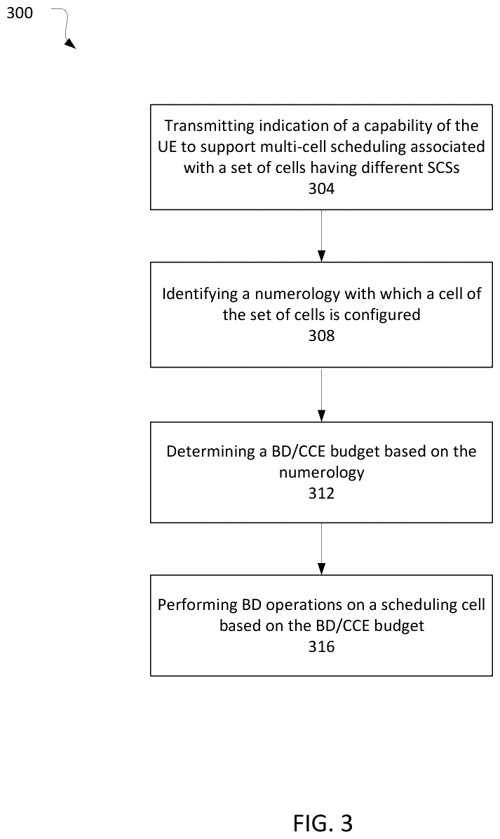

FIG. 3 is an operation flow/algorithmic structure 300 in accordance with some embodiments. For example, the operation flow/algorithmic structure 300 may be executed by a UE, such as UE 104, UE 600, or components thereof, for example, processors 604.

The operation flow/algorithmic structure 300 may include, at 304, transmitting an indication of the capability of the UE to support multi-cell scheduling associated with a set of cells having different SCSs. The set of cells may include the scheduling cell. At least two cells of the set of cells may be (re)configured with different numerologies. In some embodiments, additional/alternative capabilities may be provided with respect to the multi-cell scheduling capabilities of the UE.

The operation flow/algorithmic structure 300 may further include, at 308, identifying a numerology with which a cell of the set of cells is configured. In some embodiments, the numerology that is identified may be the lowest configured numerology among the set of cells or the highest configured numerology among the set of cells.

The operation flow/algorithmic structure 300 may further include, at 312, determining a BD/CCE budget based on the numerology identified at 308. The BD/CCE budget may include limits on a number of PDCCH candidates that may be blindly decoded by the UE in a scheduling period (for example, a slot of the scheduling cell) and a number of CCEs upon which channel estimations may be performed by the UE in the scheduling period.

The operation flow/algorithmic structure 300 may further include, at 316, performing BD operations on a scheduling cell based on the BD/CCE budget. The BD operations may include performing blind decodes on up to the maximum number of PDCCH candidates of the BD/CCE budget and performing channel estimations on up to the maximum number of CCEs of the BD/CCE budget.

While the operation flow/algorithmic structure 300 describes determining one BD/CCE budget, other embodiments may include determining a plurality of BD/CCE budgets. For example, in some embodiments a total budget may be determined/used for both multi-cell and single-cell scheduling DCI formats and one or more specific budgets may be determined/used for the single-(or multi-) cell scheduling DCI formats. In one embodiment, a total budget may be determined/used for both multi-cell and single-cell scheduling DCI formats and a legacy budget may be determined/used for single-cell scheduling DCI formats. In another embodiment, a total budget may be determined/used for both multi-cell and single-cell scheduling DCI formats, a legacy budget may be determined/used for single-cell scheduling DCI formats, and a multi-cell specific budget may be determined/used for multi-cell scheduling DCI formats. The budgets may be determined based on highest/lowest numerologies, or numerology of a scheduled cell as described herein.

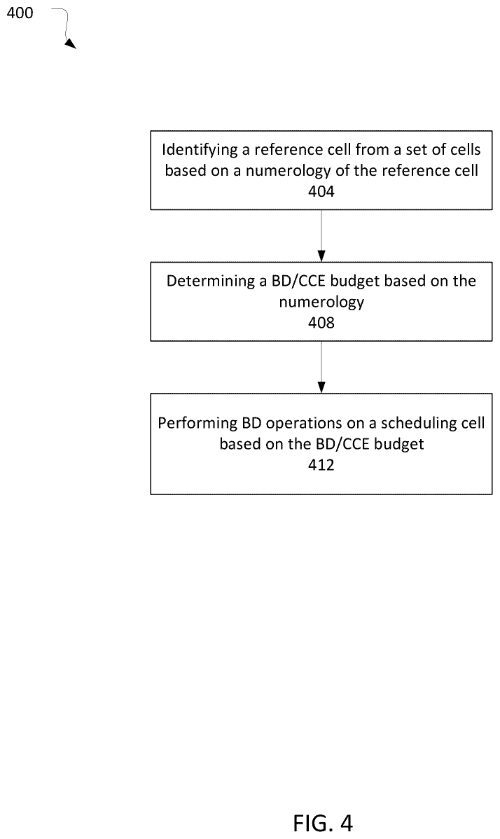

FIG. 4 is an operation flow/algorithmic structure 400 in accordance with some embodiments. For example, the operation flow/algorithmic structure 400 may be executed by a UE, such as UE 104, UE 600, or components thereof, for example, processors 604.

The operation flow/algorithmic structure 400 may include, at 404, identifying a reference cell from a set of cells. The identification may be based on a numerology of the reference cell. For example, the numerology may be the lowest numerology configured among the set of cells or a highest numerology configured among the set of cells.

The operation flow/algorithmic structure 400 may further include, at 408, determining a BD/CCE budget based on the numerology. The BD/CCE budget may include limits on a number of PDCCH candidates that may be blindly decoded by the UE in a scheduling period and a number of CCEs upon which channel estimations may be performed by the UE in the scheduling period.

The operation flow/algorithmic structure 400 may further include, at 412, performing BD operations in a scheduling cell based on the BD/CCE budget. The BD operations may include performing blind decodes on up to the maximum number of PDCCH candidates of the BD/CCE budget and performing channel estimations on up to the maximum number of CCEs of the BD/CCE budget.

While the operation flow/algorithmic structure 400 describes determining one BD/CCE budget, other embodiments may include determining a plurality of BD/CCE budgets. For example, in some embodiments the set of cells may be divided into one or more subsets, with individual subsets being associated with common SCSs. For example, if the total set of co-scheduled cells include three different SCSs, then the set may be divided into three subsets. Cells configured with a first SCS may be in a first subset, cells configured with a second SCS may be in a second subset, and cells configured with a third SCS may be in a third subset. Reference cells may then be selected from each of the subsets and BD/CCE budgets may be determined with respect to each of the reference cells.

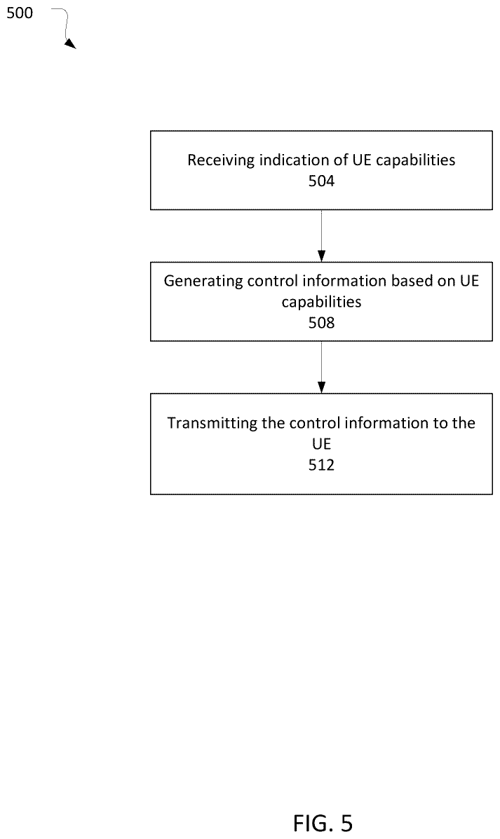

FIG. 5 is an operation flow/algorithmic structure 500 in accordance with some embodiments. For example, the operation flow/algorithmic structure 500 may be executed by a base station, such as base station 108, base station 700, or components thereof, for example, processors 704.

The operation flow/algorithmic structure 500 may include, at 504, receiving an indication of UE capabilities. The indication may correspond to one or more capabilities of the UE associated with support of co-scheduled cells having at least two different SCSs. In some embodiments, the indication may indicate one or more numbers of different SCSs the UE is capable of supporting for co-scheduled cells. In some embodiments, numbers may be given for each of a plurality of maximum number of co-scheduled cells. For example, the UE may provide a first number of different SCSs the UE is capable of supporting for up to a first maximum number of co-scheduled cells, a second number of different SCSs the UE is capable of supporting for up to a second maximum number of co-scheduled cells, etc.

In some embodiments, the capability indication may indicate one or more sets of SCS combinations the UE is capable of supporting for co-scheduled cells with a given number of different SCSs.

The operation flow/algorithmic structure 500 may further include, at 508, generating control information based on the UE capabilities. The control information may be associated with a set of co-scheduled cells. The control information may include configuration information to configure the set of co-scheduled cells. Additionally/alternatively, the control information may include DCI to schedule uplink or downlink transmissions for the UE in at least two cells of the set of co-scheduled cells. The DCI may be a multi-cell scheduling DCI format such as, for example, DCI format 1_3/0_3.

The operation flow/algorithmic structure 500 may further include, at 512, transmitting the control information to the UE. The control information may be transmitted in one or more messages.

While FIGS. 3-5 may imply an order of the operation, it should be understood that the operations may be performed in a different order or one or more of the operations may be performed concurrently in other embodiments. Additionally, it should be understood that one or more additional operations may be included in the operation flows/algorithmic structure or one or more of the operations may be omitted in other embodiments.

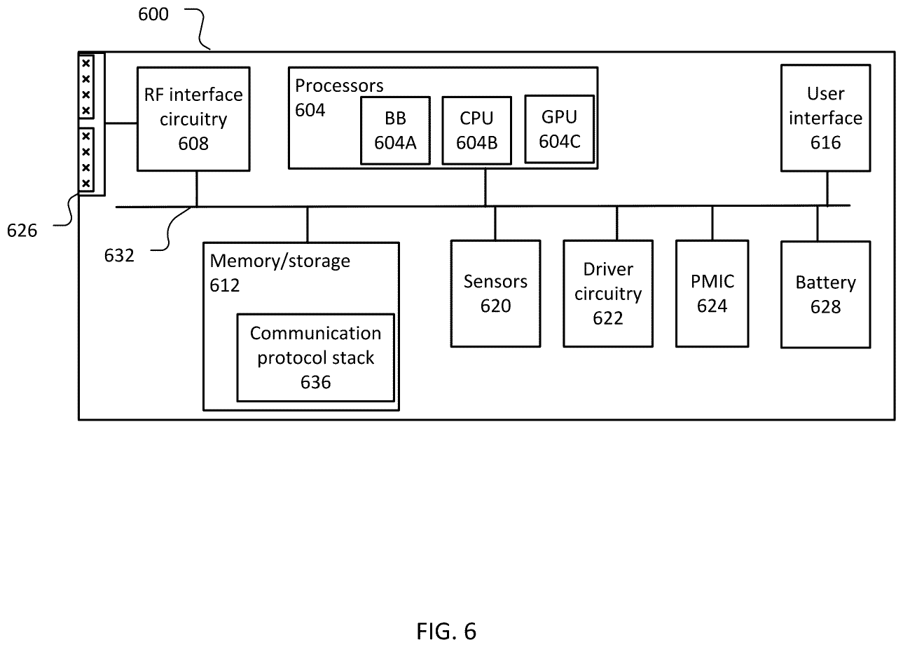

FIG. 6 illustrates an example UE 1400 in accordance with some embodiments. The UE 600 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 600 may include processors 604, RF interface circuitry 608, memory/storage 612, user interface 616, sensors 620, driver circuitry 622, power management integrated circuit (PMIC) 624, antenna structure 626, and battery 628. The components of the UE 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the UE 600. However, some of the components shown may be omitted, additional components may be present, and different arrangement of the components shown may occur in other implementations.

The components of the UE 600 may be coupled with various other components over one or more interconnects 632, which may represent any type of interface, input/output, bus (local, system, or expansion), transmission line, trace, optical connection, etc. that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the UE 600 to perform operations such as those described with respect to FIGS. 3-6 or elsewhere herein.

In some embodiments, the baseband processor circuitry 604A may access a communication protocol stack 636 in the memory/storage 612 to communicate over a 3GPP compatible network. In general, the baseband processor circuitry 604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 608.

The baseband processor circuitry 604A may generate or process baseband signals or waveforms that carry information in 3GPP-compatible networks.

The memory/storage 612 may include one or more non-transitory, computer-readable media that includes instructions (for example, communication protocol stack 636) that may be executed by one or more of the processors 604 to cause the UE 600 to perform various operations described herein. The memory/storage 612 include any type of volatile or non-volatile memory that may be distributed throughout the UE 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 608 may include transceiver circuitry and radio frequency front module (RFEM) that allows the UE 600 to communicate with other devices over a radio access network. The RF interface circuitry 608 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 626 and proceed to filter and amplify (with a low-noise amplifier) the signal. The signal may be provided to a receiver of the transceiver that down-converts the RF signal into a baseband signal that is provided to the baseband processor of the processors 604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 626.

In various embodiments, the RF interface circuitry 608 may be configured to transmit/receive signals in a manner compatible with NR access technologies.

The antenna structure 626 may include antenna elements to convert electrical signals into radio waves to travel through the air and to convert received radio waves into electrical signals. The antenna elements may be arranged into one or more antenna panels. The antenna structure 626 may have antenna panels that are omnidirectional, directional, or a combination thereof to enable beamforming and multiple input, multiple output communications. The antenna structure 626 may include microstrip antennas, printed antennas fabricated on the surface of one or more printed circuit boards, patch antennas, phased array antennas, etc. The antenna structure 626 may have one or more panels designed for specific frequency bands including bands in FR1 or FR2.

The user interface 616 includes various input/output (I/O) devices designed to enable user interaction with the UE 600. The user interface 616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 600.

The sensors 620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 622 may include software and hardware elements that operate to control particular devices that are embedded in the UE 600, attached to the UE 600, or otherwise communicatively coupled with the UE 600. The driver circuitry 622 may include individual drivers allowing other components to interact with or control various input/output (I/O) devices that may be present within, or connected to, the UE 600. For example, driver circuitry 622 may include a display driver to control and allow access to a display device, a touchscreen driver to control and allow access to a touchscreen interface, sensor drivers to obtain sensor readings of sensors 620 and control and allow access to sensors 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage power provided to various components of the UE 600. In particular, with respect to the processors 604, the PMIC 624 may control power-source selection, voltage scaling, battery charging, or DC-to-DC conversion.

In some embodiments, the PMIC 624 may control, or otherwise be part of, various power saving mechanisms of the UE 600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 600 may power down for brief intervals of time and thus save power. If there is no data traffic activity for an extended period of time, then the UE 600 may transition off to an RRC_Idle state, where it disconnects from the network and does not perform operations such as channel quality feedback, handover, etc. The UE 600 goes into a very low power state, and it performs paging where again it periodically wakes up to listen to the network and then powers down again. The UE 600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 628 may power the UE 600, although in some examples the UE 600 may be mounted deployed in a fixed location and may have a power supply coupled to an electrical grid. The battery 628 may be a lithium-ion battery, a metal-air battery, such as a zinc-air battery, an aluminum-air battery, a lithium-air battery, and the like. In some implementations, such as in vehicle-based applications, the battery 628 may be a typical lead-acid automotive battery.

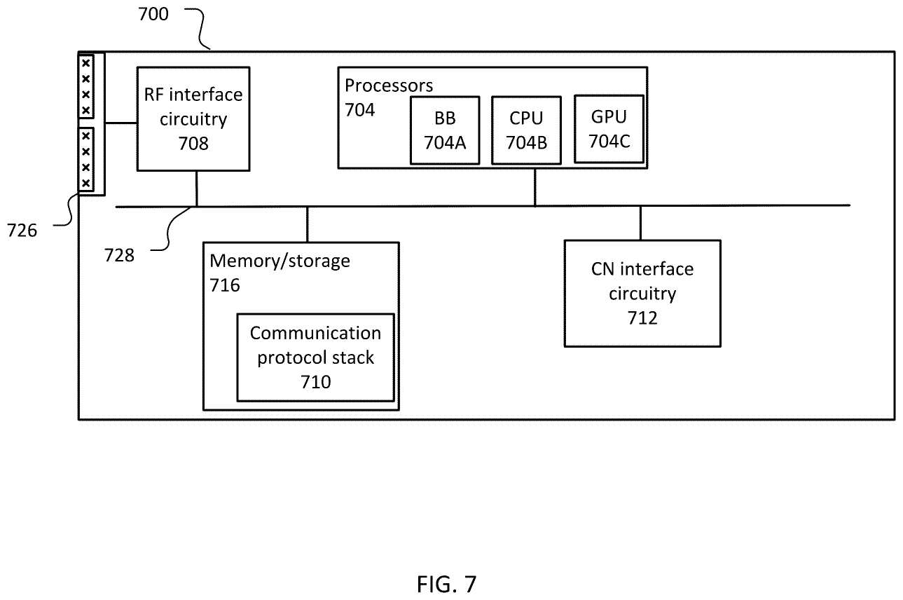

FIG. 7 illustrates an example base station 700 in accordance with some embodiments. The base station 700 may include processors 704, RF interface circuitry 708, core network (CN) interface circuitry 712, memory/storage circuitry 716, and antenna structure 726.

The components of the base station 700 may be coupled with various other components over one or more interconnects 728.

The processors 704, RF interface circuitry 708, memory/storage circuitry 716 (including communication protocol stack 710), antenna structure 726, and interconnects 728 may be similar to like-named elements shown and described with respect to FIG. 6.

The processors 704 may include any type of circuitry or processor circuitry that executes or otherwise operates computer-executable instructions, such as program code, software modules, or functional processes from memory/storage circuitry 716 to cause the base station 700 to perform operations such as those described with respect to FIGS. 3-6 or elsewhere herein.

The CN interface circuitry 712 may provide connectivity to a core network, for example, a 5th Generation Core network (5GC) using a 5GC-compatible network interface protocol such as carrier Ethernet protocols, or some other suitable protocol. Network connectivity may be provided to/from the base station 700 via a fiber optic or wireless backhaul. The CN interface circuitry 712 may include one or more dedicated processors or FPGAs to communicate using one or more of the aforementioned protocols. In some implementations, the CN interface circuitry 712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method to be implemented by a user equipment (UE), the method comprising: transmitting, to a base station, an indication of a capability of the UE to support multi-cell scheduling associated with a set of cells having at least two different sub-carrier spacings (SCSs); identifying a numerology with which a cell of the set of cells is configured; determining a blind decoding (BD)/control channel element (CCE) budget based on the numerology; and performing BD operations on a scheduling cell based on the BD/CCE budget.

Example 2 includes a method of example 1 or some other example herein, wherein the BD/CCE budget comprises a first number of candidates for BD and a second number of CCEs for channel estimation.

Example 3 includes a method of example 1 or some other example herein, wherein identifying the numerology comprises: identifying the numerology based on a determination that the numerology is a lowest configured numerology of the set of cells.

Example 4 includes a method of example 3 or some other example herein, wherein the BD/CCE budget is a first BD/CCE budget for BD operations to identify multi-cell scheduling downlink control information (DCI) formats and single-cell scheduling DCI formats, and the method further comprises: determining a second BD/CCE budget for BD operations to identify single-cell scheduling DCI formats.

Example 5 includes a method of example 4 or some other example herein, wherein the numerology is a first numerology and said determining the second BD/CCE budget comprises: identifying a second numerology that is associated with a first cell of the set of cells, wherein the first cell is to be scheduled by a single-cell scheduling DCI format; and determining the second BD/CCE budget based on the second numerology.

Example 6 includes a method of example 1 or some other example herein, wherein identifying the numerology comprises: identifying the numerology based on a determination that the numerology is a highest configured numerology of the set of cells.

Example 7 includes a method of example 6 or some other example herein, wherein the BD/CCE budget is a first BD/CCE budget for BD operations to identify multi-cell scheduling downlink control information (DCI) formats, and the method further comprises: determining a second BD/CCE budget for BD operations to identify both multi-cell scheduling DCI formats and single-cell scheduling DCI formats; and determining a third BD/CCE budget for BD operations to identify single-cell scheduling DCI formats.

Example 8 includes a method of example 7 or some other example herein, wherein the numerology is a first numerology and the method further comprises: identifying a second numerology based on a determination that the second numerology is a lowest configured numerology of the set of cells; determining the second BD/CCE budget based on the second numerology; and determining the third BD/CCE budget based on a third numerology that is associated with a first cell of the set of cells, wherein the first cell is to be scheduled by a single-cell scheduling DCI format.

Example 9 includes a method of example 1 or some other example herein, wherein the set of cells includes the scheduling cell.

Example 10 includes a method to be implemented by a user equipment (UE) that supports multi-cell scheduling associated with a set of cells having at least two different sub-carrier spacings (SCSs), the method comprising: identifying a reference cell from the set of cells based on a numerology of the reference cell; determining a blind decoding (BD)/control channel element (CCE) budget based on the numerology; and performing BD operations on a scheduling cell based on the BD/CCE budget.

Example 11 includes the method of example 10 or some other example herein, wherein the BD/CCE budget comprises a first number of candidates for BD and a second number of CCEs for channel estimation.

Example 12 includes the method of example 10 or some other example herein, wherein identifying the reference cell based on the numerology comprises: identifying the reference cell based on a determination that the numerology is a highest configured numerology of the set of cells.

Example 13 includes the method of example 10 or some other example herein, wherein identifying the reference cell based on the numerology comprises: identifying the reference cell based on a determination that the numerology is a lowest configured numerology of the set of cells.

Example 14 includes the method of example 10 or some other example herein, wherein the set of cells includes at least two cells with the numerology and the method further comprises: selecting the reference cell from the at least two cells based on network signaling or a predetermined configuration.

Example 15 includes a method of example 10 or some other example herein, wherein the numerology is a first numerology, the set of cells includes a first subset of one or more cells having the first numerology and a second subset of one or more cells having a second numerology, the reference cell is a first reference cell selected from the first subset, and the method further comprises: selecting a second reference cell from the second subset.

Example 16 includes the method of example 15 or some other example herein, wherein the BD/CCE budget is a first BD/CCE budget and the method further comprises: determining a second BD/CCE budget based on the second numerology; and performing BD operations on the scheduling cell based on the second BD/CCE budget.

Example 17 includes a method to be implemented by a base station, the method comprising: receiving, from a user equipment (UE), an indication of one or more capabilities of the UE associated with support of co-scheduled cells having at least two different sub-carrier spacings (SCSs); generating, based on the indication of the one or more capabilities, control information associated with a set of co-scheduled cells, wherein the control information includes configuration information to configure the set of co-scheduled cells or downlink control information (DCI) to schedule uplink or downlink transmissions for the UE in at least two cells of the set of co-scheduled cells; and transmitting the control information to the UE.

Example 18 includes a method of example 17 or some other example herein, wherein the indication of the one or more capabilities is to indicate a number of different SCSs the UE is capable of supporting for co-scheduled cells.

Example 19 includes the method of example 18 or some other example herein, wherein the number is a first number of different SCSs the UE is capable of supporting for up to a first maximum number of co-scheduled cells and the indication of the one or more capabilities is to further indicate a second number of different SCSs the UE is capable of supporting for up to a second maximum number of co-scheduled cells.

Example 20 includes the method of example 18 or some other example herein, wherein the indication of the one or more capabilities comprises an indication of one or more sets of SCS combinations the UE is capable of supporting for co-scheduled cells with the number of different SCSs.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
generate, for transmission to a base station, an indication of a capability of a user equipment (UE) to support multi-cell scheduling associated with a set of cells having at least two different sub-carrier spacings (SCSs);
identify a numerology with which a cell of the set of cells is configured;
determine a blind decoding (BD)/control channel element (CCE) budget based on the numerology; and
perform BD operations on a scheduling cell based on the BD/CCE budget.

2. The one or more non-transitory, computer-readable media of claim 1, wherein the BD/CCE budget comprises a first number of candidates for BD and a second number of CCEs for channel estimation.

3. The one or more non-transitory, computer-readable media of claim 1, wherein the instructions, when executed, further cause the processing circuitry to:
identify the numerology based on a determination that the numerology is a lowest configured numerology of the set of cells.

4. The one or more non-transitory, computer-readable media of claim 3, wherein the BD/CCE budget is a first BD/CCE budget for BD operations to identify multi-cell scheduling downlink control information (DCI) formats and single-cell scheduling DCI formats, and the instructions, when executed, further cause the processing circuitry to:
determine a second BD/CCE budget for BD operations to identify single-cell scheduling DCI formats.

5. The one or more non-transitory, computer-readable media of claim 4, wherein the numerology is a first numerology and the instructions, when executed, further cause the processing circuitry to:
identify a second numerology that is associated with a first cell of the set of cells, wherein the first cell is to be scheduled by a single-cell scheduling DCI format; and
determine the second BD/CCE budget based on the second numerology.

6. The one or more non-transitory, computer-readable media of claim 1, wherein the instructions, when executed, further cause the processing circuitry to:
identify the numerology based on a determination that the numerology is a highest configured numerology of the set of cells.

7. The one or more non-transitory, computer-readable media of claim 6, wherein the BD/CCE budget is a first BD/CCE budget for BD operations to identify multi-cell scheduling downlink control information (DCI) formats, and the instructions, when executed, further cause the processing circuitry to:
determine a second BD/CCE budget for BD operations to identify both multi-cell scheduling DCI formats and single-cell scheduling DCI formats; and
determine a third BD/CCE budget for BD operations to identify single-cell scheduling DCI formats.

8. The one or more non-transitory, computer-readable media of claim 7, wherein the numerology is a first numerology and the instructions, when executed, further cause the processing circuitry to:
identify a second numerology based on a determination that the second numerology is a lowest configured numerology of the set of cells;
determine the second BD/CCE budget based on the second numerology; and
determine the third BD/CCE budget based on a third numerology that is associated with a first cell of the set of cells, wherein the first cell is to be scheduled by a single-cell scheduling DCI format.

9. The one or more non-transitory, computer-readable media of claim 1, wherein the set of cells includes the scheduling cell.

10. A method associated with a user equipment (UE) that supports multi-cell scheduling associated with a set of cells having at least two different sub-carrier spacings (SCSs), the method comprising:
identifying a reference cell from the set of cells based on a numerology of the reference cell;
determining a blind decoding (BD)/control channel element (CCE) budget based on the numerology; and
performing BD operations on a scheduling cell based on the BD/CCE budget.

11. The method of claim 10, wherein the BD/CCE budget comprises a first number of candidates for BD and a second number of CCEs for channel estimation.

12. The method of claim 10, wherein identifying the reference cell based on the numerology comprises:
identifying the reference cell based on a determination that the numerology is a highest configured numerology of the set of cells.

13. The method of claim 10, wherein identifying the reference cell based on the numerology comprises:
identifying the reference cell based on a determination that the numerology is a lowest configured numerology of the set of cells.

14. The method of claim 10, wherein the set of cells includes at least two cells with the numerology and the method further comprises:
selecting the reference cell from the at least two cells based on network signaling or a predetermined configuration.

15. The method of claim 10, wherein the numerology is a first numerology, the set of cells includes a first subset of one or more cells having the first numerology and a second subset of one or more cells having a second numerology, the reference cell is a first reference cell selected from the first subset, and the method further comprises:
selecting a second reference cell from the second subset.

16. The method of claim 15, wherein the BD/CCE budget is a first BD/CCE budget and the method further comprises:
determining a second BD/CCE budget based on the second numerology; and
performing BD operations on the scheduling cell based on the second BD/CCE budget.

17. An apparatus comprising:
processing circuitry to:
receive, from a user equipment (UE), an indication of one or more capabilities of the UE associated with support of co-scheduled cells having at least two different sub-carrier spacings (SCSs);
generate, based on the indication of the one or more capabilities, control information associated with a set of co-scheduled cells, wherein the control information includes configuration information to configure the set of co-scheduled cells or downlink control information (DCI) to schedule uplink or downlink transmissions for the UE in at least two cells of the set of co-scheduled cells, the control information to be transmitted to the UE; and
interface circuitry to communicatively couple the processing circuitry to a component of a device.

18. The apparatus of claim 17, wherein the indication of the one or more capabilities is to indicate a number of different SCSs the UE is capable of supporting for co-scheduled cells.

19. The apparatus of claim 18, wherein the number is a first number of different SCSs the UE is capable of supporting for up to a first maximum number of co-scheduled cells and the indication of the one or more capabilities is to further indicate a second number of different SCSs the UE is capable of supporting for up to a second maximum number of co-scheduled cells.

20. The apparatus of claim 18, wherein the indication of the one or more capabilities comprises an indication of one or more sets of SCS combinations the UE is capable of supporting for co-scheduled cells with the number of different SCSs.
